(19) United States
(12) Patent Application Publication
(10) Pub. No.: US 2025/0079143 A1
(43) Pub. Date: Mar. 6, 2025

(54) MASS ANALYSIS

(71) Applicant: DH Technologies Development Pte. Ltd., Singapore (SG)

(72) Inventor: Stephen TATE, Barrie (CA)

(21) Appl. No.: 18/714,055

(22) PCT Filed: Dec. 6, 2022
(86) PCT No.: PCT/IB2022/061793

§ 371 Date: May 28, 2024

Related U.S. Application Data
(60) Provisional application No. 63/290,485, filed on Dec. 16, 2021.

(51) Int. Cl. H01J 49/04

(52) U.S. Cl. CPC H01J 49/0409

(57) ABSTRACT

Systems, apparatus, and computer-readable storage media are disclosed for analyzing samples of a well plate. Systems may include a well plate, a mass spectrometer, and a computing device. The well plate may include rows of wells. The mass spectrometer may sequentially capture a sample from each well of the rows of wells and generate spectral data that includes mass spectrum data for each captured sample. The computing device may receive the spectral data generated by the mass spectrometer, detect rows of spectral data in the spectral data, wherein each row of spectral data corresponds to a row of wells in the well plate; and generate a spectral data matrix from the detected rows of spectral data such that each row of wells comprises a corresponding row of spectral data in the spectral data matrix.

### RELATED APPLICATIONS

The present application claims the priority benefit of U.S. Provisional Patent Application Ser. No. 63/290,485, filed on Dec. 16, 2021, the content of which is hereby incorporated by reference, in its entirety into this disclosure.

### FIELD

The present disclosure relates generally to sample analysis, and more particularly to such analyses involving measurements through the use of mass spectrometry.

### BACKGROUND

The preparation and introduction of sample into a mass spectrometer is conventionally a relatively time-consuming process, particularly where rapid and efficient analysis of multiple samples, which may or may not be analytically related, is desired. In some areas of study, for example, it would be useful to be able to process multiple samples in quick succession, such as in high throughput screening procedures for instance that involve the analysis of different samples contained in individual wells of a well plate.

Current methods of performing high throughput screening of multiple samples using a mass spectrometer involve capturing in one capture data file, all the measurements of the various samples being analyzed in a continuous run. Post-acquisition, the capture data file is processed to split out individual measurements for the sample from each well into their own data file. Each of these files can then be analyzed individually to determine components or information on the sample contained in each well.

To date there has not been an effective mechanism for employing sensitive analytical mass spectrometers in high throughput screening due to the delay in sample preparation, introduction required with current techniques, and post-acquisition data processing that is required.

As such, there may be benefits from techniques which increase an effective sampling rate of mass spectrometers.

### SUMMARY

In various aspects and embodiments, a system may include a well plate, a mass spectrometer, and computing device coupled to the mass spectrometer. The well plate may include rows of wells. The mass spectrometer may sequentially capture a sample from each well of the rows of wells and generate spectral data that includes mass spectrum data for each captured sample. The computing device may receive the spectral data generated by the mass spectrometer, detect rows of spectral data in the spectral data, wherein each row of spectral data corresponds to a row of wells in the well plate, and generate a spectral data matrix from the detected rows of spectral data such that each row of wells comprises a corresponding row of spectral data in the spectral data matrix.

In various aspects and other embodiments, a computing device may include an interface configured to receive spectral data from a mass spectrometer, a storage device, and a processor configured to execute instructions stored in a memory. Execution of the instructions may cause the processor to detect rows of spectral data in the spectral data received from the mass spectrometer, wherein each row of spectral data corresponds to a row of wells in a well plate, and generate a spectral data matrix from the detected rows of spectral data such that each row of wells in the well plate comprises a corresponding row of spectral data in the spectral data matrix.

In various aspects and additional embodiments, a non-transitory computer-readable storage medium may include instructions. In response to the instructions being executed, a computing device may detect rows of spectral data in spectral data received from a mass spectrometer, wherein each row of spectral data corresponds to a row of wells in a well plate, and generate a spectral data matrix from the detected rows of spectral data such that each row of wells in the well plate comprises a corresponding row of spectral data in the spectral data matrix.

In some embodiments, the computing device may store the spectral data to a storage device, and detect the rows of spectral data from the spectral data stored to the storage device. In further embodiments, the computing device may store the spectral data matrix to a storage device. In certain embodiments, the spectral data generated by the mass spectrometer includes gaps or periods of reduced ion intensity that correspond to transitioning of a sample capture probe of the mass spectrometer between rows of wells, and the computing device is configured to detect rows of spectral data based on the gaps or periods of reduced ion intensity that correspond to transitioning of the sample capture probe between rows of wells. The further embodiments, the spectral data generated by the mass spectrometer comprises gaps or periods of reduces ion intensity that correspond to transitioning of a sample capture probe of the mass spectrometer between wells in a row of wells. In such embodiments, the computing device may correlate spectral data to a particular well in the rows of wells based on the gaps or periods of reduced ion intensity that correspond to transitioning of the sample capture probe between wells in the row of wells.

The various aspects and embodiments of the present disclosure include systems, methods, devices, components, and/or software for implementing the various functions and processes described herein.

### DESCRIPTION OF DRAWINGS

Various aspects and embodiments of the present disclosure are shown in the drawings and described therein and elsewhere throughout the disclosure. In the drawings, like references indicate like parts.

FIG. 1 depicts a high-level block diagram of an example mass analysis system in accordance with various aspects and embodiments of the present disclosure.

FIG. 2 depicts further details of an example embodiment of the computing device depicted in FIG. 1.

FIG. 3 depicts further details of an example embodiment of the mass analysis system in FIG. 1.

FIG. 4A depicts an example embodiment of the well plate of FIGS. 1 and 3 and an example sampling path of the wells.

FIG. 4B depicts an example embodiment of the well plate of FIGS. 1 and 3 and another example sampling path of the wells.

FIG. 5 illustrates spectral data generated by the mass spectrometer of FIG. 1

FIG. 6 depicts a flowchart of an example process for generating a spectral matrix from spectral data generated by the mass spectrometer of FIG. 1.

FIG. 7 depicts a two-dimensional heat map of spectral matrix generated per the process of FIG. 6.

### DETAILED DESCRIPTION

In various aspects and embodiments of the present disclosure, systems, components, and devices, and combinations thereof, are provided for analyzing substance samples, and particularly for analyzing of pluralities of substance samples.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry, for example, may operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module”, for example, may refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.”

As utilized herein, the term “exemplary” means serving as a non-limiting example, instance, or illustration. Further, as utilized herein, the terms “for example” and “e.g.,” set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a semiconductor device may be turned sideways so that its “top” surface is facing horizontally and its “side” surface is facing vertically, without departing from the teachings of the present disclosure.

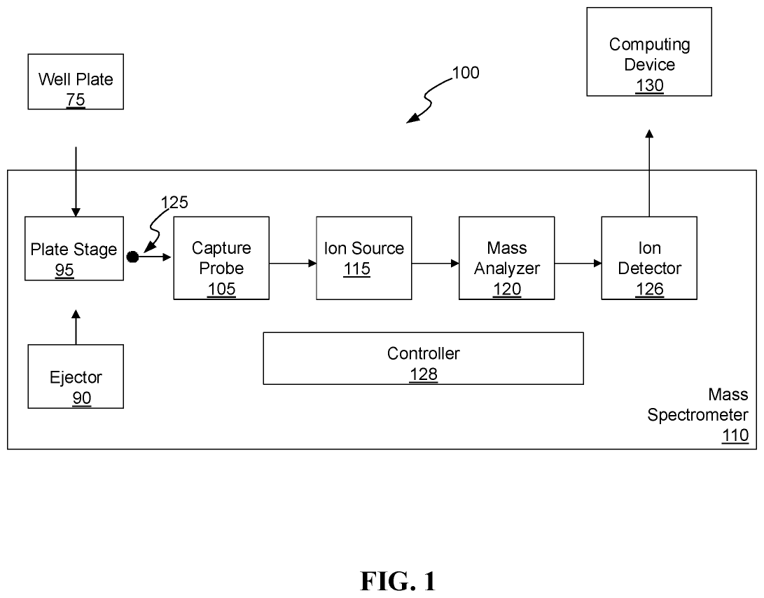

Referring now to FIG. 1, an example embodiment of a mass analysis system 100 is shown. As shown, the mass analysis system 100 may include a mass spectrometer 110, a computing device 130 coupled to the mass spectrometer 110, and a well plate 75 providing samples to the mass spectrometer 110.

The mass spectrometer 110 may separate and detect ions of interest from a given sample. The one or more computing devices 130 may be operative to control operation of the mass spectrometer 110, receive spectral data generated by the mass spectrometer, and manage the spectral data received from the mass spectrometer 110. Typically, the mass spectrometer 110 may format a detected ion signal generated by the ion detector 126 in spectral data representative of one or more mass spectra. The one or more computing devices 130 may receive the spectral data from the mass spectrometer 110 and analyze the spectral data to produce one or more data reports, graphs, etc.

The mass spectrometer 110 may analyze ions generated from ionization of samples provided by well plate 75. To this end, the mass spectrometer 110 may include an ejector 90, a plate stage 95, a capture probe 105, an ion source 115, a mass analyzer 120, an ion detector 126, and a controller 128. The plate stage 95 may receive a well plate 75 containing prepared samples to be analyzed. The ejector 90 may eject a sample droplet 125 from the well plate 75. The capture probe 105 may capture the sample droplet 125 and provide an ionized sample droplet to other components of the mass spectrometer 110. In some embodiments, the ejector 90, the probe stage 95, and the capture probe 105 may be part of an ejection system. Such an ejection system may be an external component that is distinct and separable from the other components of the mass spectrometer 110.

In general, the plate stage 95 may locate each sample of the well plate 75 proximate to the capture probe 105 and the ejector 90 may selectively eject the located sample into the capture probe 105. More specifically, the ejector 90 may eject sample droplets 125 from wells of the well plate 75. The ejector 90 may be any type of suitable ejector, such as an acoustic ejector or a pneumatic ejector. In an example embodiment, the plate stage 95 receives the well plate 75 and positions the well plate 75 such that a selected well of the well plate 75 is aligned with a capture opening of the capture probe 105. While aligned with the capture opening of the capture probe 105, the ejector 90 may eject a sample droplet 125 from the selected well of the well plate 75. The capture probe 105 may be operative to capture the sample droplet 125 via its capture opening, optionally dilute the captured droplet 125, and transport the sample droplet 125 to the ion source 115 of the mass spectrometer 110. The plate stage 95 may include one or more electro-mechanical devices, such as a translation stage that translates the well plate 75 in an x-y plane to align wells of the well plate 75 with the ejector 90 and/or or the capture probe 105.

The controller 128 may be operatively coupled to the ejector 90, plate stage 95, capture probe 105, ion source 115, mass analyzer 120, and ion detector 126 in order to controller the respective components. In particular, the controller 128 may be configured to operate the ejector 90 and plate stage 95 so as to position a sample of the well plate 75 and eject a sample droplet 125 into the capture probe 105. The controller 330 may be, but is not limited to, a microcontroller, a computer, a microprocessor, or any device capable of sending and receiving control signals and data. Wired or wireless connections between the controller 128 and the remaining elements of the mass spectrometer 110 are not depicted but would be apparent to a person of skill in the art.

In operation, the ejector 90 and stage plate 95 may iteratively deliver independent samples from wells of the well plate 75 to the capture probe 105. The capture probe 105 may dilute and transport each such delivered sample to the ion source 115 disposed downstream of the capture probe 105. A mass analyzer 120 may receive the generated ions from the ion source 115 for mass analysis. The mass analyzer 120 may be operative to selectively separate ions of interest from generated ions received from the ion source 115 and to deliver the ions of interest to an ion detector 126 that generates a mass spectrometer signal indicative of detected ions to the one or more computing devices 130. In some aspects, the separate ions of interest may be indicated in an analysis instruction associated with that sample. In some aspects, the separate ions of interest may be indicated in an analysis instruction identified by an indicia physically associated with the plurality of samples.

For example, the mass analysis system 100 may further comprise the generation, assignment, and use of identifiers associated with collections of samples and/or individual samples. In such embodiments, the capture probe 105 and/or other components of mass spectrometer 110 may include readers that are capable of reading such identifiers associated with the collections of samples and/or the individual samples. For instance, an identifier associated with a well plate 75 may be read or scanned as it is received by the plate stage 95. In such aspects, the identifier(s) may be used by the mass spectrometer 110 and/or the mass analysis system 100 to associate spectral data with sample droplets 125. In some aspects, the identifier may comprise an indicia physically associated with the plurality of samples. In some aspects, the indicia may be readable by optical, electrical, magnetic, or other non-contact reading means. Indicia or identifiers in accordance with such aspects of the disclosure may include any characters, symbols, or other devices suitable for use in adequately identifying samples, sample collections, and/or handling or analysis instructions suitable for use in implementing the various aspects and embodiments of the present disclosure.

As shown, the mass spectrometer 110 may be coupled to one or more computing devices 130. The one or more computing devices 130 may control operation of the mass spectrometer 110, receive spectral data from the mass spectrometer 110, analyze the spectral data, and present results of such analysis of the spectral data. To this end, the one or more computing devices 130 may include, for example, one or more SciexOS® and/or Analyst® computing devices available from Sciex LLC. The Analyst® and/or SciexOS® computing devices may include a control component for the capture probe 105, represented for example by Sciex open port probe (OPP) (also referred to as an open port interface (OPI)) software, and a control component for other components of the mass spectrometer 110 (e.g., ejector 90, plate stage 95, ion source 115, mass analyzer 120, and/or ion detector 126).

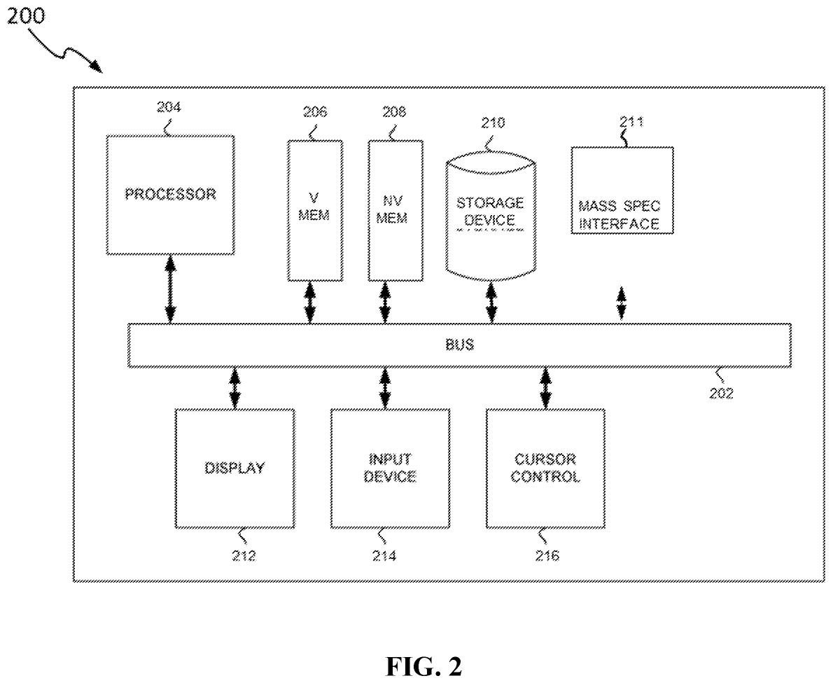

The one or more computing devices 130 may comprise a single computing device or may comprise a plurality of distributed computing devices in operative communication with the mass spectrometer 110 and/or one another. FIG. 2 illustrates a high-level block diagram of an example computing device 200 which may implement one or more of the computing devices 130. To this end, the computing device 200 may comprise a bus 202, a processor 204, volatile memory 206, non-volatile storage 208, storage device 210, and a mass spectrometer interface 211. The bus 202 may comprise various signal lines, interfaces, etc., that operatively interconnect components of the computing device 200 such as processor 204, volatile memory 206, non-volatile storage 208, storage device 210, and mass spectrometer interface 211 to permit transfers of information and/or control signals between such components of the computing device 200.

The processor 204 may include a plurality of processing elements or cores, which may be packaged as a single processor or in a distributed arrangement. Furthermore, in some embodiments, a plurality of virtual processing elements may be provided to provide the control or management operations for the computing device 200.

The memory 206 may include random access memory (RAM) and/or other dynamic storage devices coupled to bus 202. The memory 206 may store instructions executed by processor 204. The memory 206 may also store temporary variables, intermediate information, and/or other data resulting from execution of the instructions by processor 204. The non-volatile memory 208 may include read-only-memory (ROM) 208 devices, flash memory devices, and/or other non-volatile memory coupled to bus 202. The non-volatile memory 208 may store static information and instructions for processor 204. The storage device 210 may include one or more magnetic disk drives, optical disk drives, solid-state disk drives, and/or other mass storage devices coupled to bus 202. The storage device 210 may store information and/or instructions in a persistent manner for processor 204.

The processor 204 may be coupled via bus 202 to the mass spectrometer interface 211. The mass spectrometer interface 211 may operatively couple the computing device 200 and processor 204 to the mass spectrometer 110 and its components. To this end, the mass spectrometer interface 211 may include various I/O and/or networking interfaces. For example, the mass spectrometer interface 211 may include I/O interfaces such as Universal Serial Bus (USB) interfaces, Peripheral Component Interconnect (PCI) interfaces, PCI Express interfaces, Serial Peripheral Interface (SPI) interfaces, FireWire interfaces, etc. Alternatively or additionally, the mass spectrometer interface 211 may include one or more networking interfaces such as Ethernet interfaces, Wi-Fi interfaces, and Bluetooth interfaces.

The processor 204 may be further coupled via bus 202 to a display 212, such as a light emitting diode (LED) or liquid crystal display (LCD). The processor 204 may use the display 212 to present information to a computer user. An input device 214, including alphanumeric and other keys, may be coupled to bus 202. A computer user may utilize the input device to communicate information and command selections to processor 204. The computing device 200 may further include a cursor control 216 coupled to the bus 202. The cursor control 216 may comprise as a mouse, a trackball, cursor direction keys, etc. which permit a computer user to select graphical elements or other aspects presented via the display 212. In some embodiments, the cursor control 216 may control movement of a cursor on display 212 used to select such graphical elements or other aspects presented via the display 212. The cursor control 216 typically has two degrees of freedom in two axes, a first axis (e.g., a horizontal axis or x-axis) and a second axis (e.g., a vertical axis or y-axis), that permits the cursor control 216 to move a cursor across a plane of the display 212 and select an x-y position in the plane.

Consistent with certain implementations of the present disclosure, the computing device 200 may operate based on processor 204 executing instructions stored in memory 206. Such instructions may be read into memory 206 from another computer-readable medium, such as storage device 210. Execution of the instructions stored in memory 206 may cause processor 204 to perform various processes described herein. Alternatively, hard-wired circuitry may be used in place of or in combination with software instructions to implement various processes described herein. Thus, implementations of the present disclosure may utilize hardware circuitry and/or software to perform the various processes describe herein.

In various embodiments, the computing device 200 may be connected to one or more other computing devices across a network to form a networked system. Such other computing devices may be implemented in a manner similar to computing device 200. The network may comprise a private network or a public network such as the Internet. In the networked system, one or more computing devices may store and serve the data to other computing devices. The one or more computing devices 200 that store and serve the data may be referred to as servers, data servers, and/or a data cloud in a various cloud-computing scenarios. In some embodiment, the one or more computing devices 200 may include one or more web servers that provide other computing devices with web interfaces, web APIs, and/or other access to data and other resources of the one or more computing device. Such computing devices that send and receive data to and from the servers, data servers, and/or the data cloud regardless of whether via such web servers or web APIs may be referred to as client devices and/or cloud devices.

The term “computer-readable medium” as used herein refers to any media that participates in providing instructions to processor 204 for execution. Such a medium may take many forms including transitory media (e.g., transmission media) and non-transitory media (e.g., non-volatile media and volatile media). Transmission media may include, for example, coaxial cables, copper wire, fiber optics, the wires that comprise bus 202, and wireless transmissions. Non-volatile media may include, for example, non-volatile storage devices such as those of the non-volatile memory 208 and/or the storage device 210. Similarly, the volatile media may include, for example, volatile storage devices such as those of the volatile memory 206.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer may read.

Various forms of computer-readable media may be involved in carrying one or more sequences of one or more instructions to processor 204 for execution. For example, the instructions may initially be carried on the magnetic disk of a remote computer. The remote computer may load the instructions into its dynamic memory and send the instructions over a communications link. A modem or other network interface local to the computing device 200 may receive the instructions transfer the received instructions to memory 206 and/or processor 204 via bus 202. The instructions received by memory 206 may optionally be stored to storage device 210 either before or after execution by processor 204.

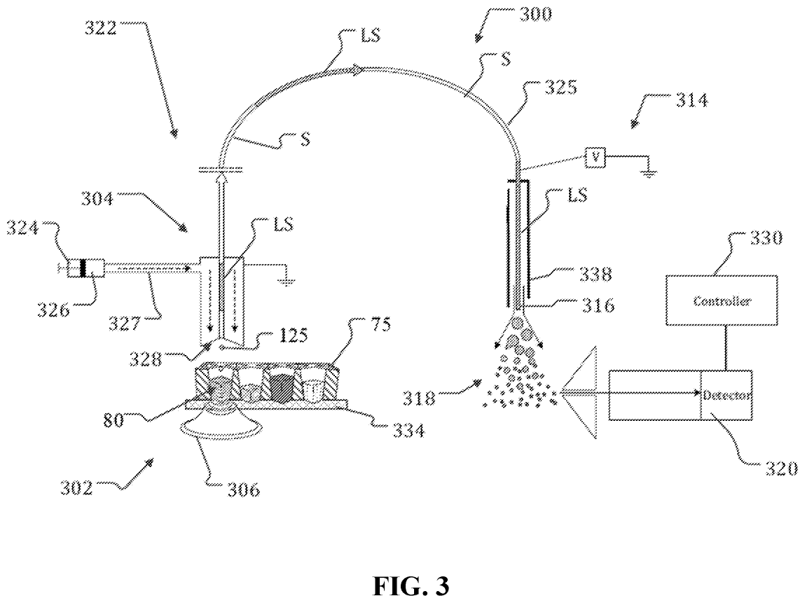

Referring now to FIG. 3, an example embodiment is shown of a mass spectrometer 300 that may be used to implement the mass spectrometer 110 of FIG. 1. The mass spectrometer 300 may include an acoustic droplet ejection (ADE) system 302, which may be used to implement the ejector 90 of FIG. 1, an open port interface (OPI) probe 304, which may be used to implement the capture probe 105 of FIG. 1, an electrospray ionization (ESI) source 314, which may be used to implement the ion source 115 of FIG. 1, a mass analyzer detector 320, which may be used to implement the mass analyzer 120 and the ion detector 126 of FIG. 1, a controller 330, which may be used to implement that controller 128 of FIG. 1, and a movable plate stage 334, which may be used to implement the plate stage 95 of FIG. 1.

The ADE system 302 may include an acoustic ejector 306 that ejects a sample droplet 125 from a well plate 75 into the open end of the OPI probe 304. The OPI probe 304 may be in fluidic communication with the ESI source 314. The ESI source 314 may include a nebulizer probe 338 and an electrospray electrode 316 that ionize and discharge an ionized samples into an ionization chamber 318. Due to the configuration of the nebulizer probe 338 and the electrospray electrode 316, the samples ejected therefrom are in the gas phase. The mass analyzer detector 320 may be coupled to the ionization chamber 318 to receive the ionized sample. The mass analyzer detector 320 may process and/or detect ions of the ionized sample generated by the ESI source 314.

A liquid handling system 322 may include one or more pumps 324, one or more conduits 325, 327, and a solvent reservoir 326. The liquid handling system 322 generally controls a flow of a transport fluid or liquid from the solvent reservoir 326 to the OPI probe 304 and from the OPI probe 304 to the ESI source 314. The solvent reservoir 326 may contain transport solvent such as a liquid, desorption solvent. The solvent reservoir 326 may be in fluidic communication with the OPI probe 304 via the supply conduit 327. The pump 324 may deliver the transport solvent from the solvent reservoir 326 to the OPI probe 304 via the supply conduit 327 at a selected volumetric rate. To this end, the pump 324 may include a reciprocating pump, a positive displacement pump such as a rotary, gear, plunger, piston, peristaltic, diaphragm pump, or other pump such as a gravity, impulse, pneumatic, electrokinetic, and centrifugal pump. The flow of transport solvent into and out of the OPI probe 304 occurs within a sample space accessible at the open end such that one or more sample droplets 125 may be introduced into the liquid boundary 328 at an end of the OSI probe 304 and subsequently delivered to the ESI source 314.

The acoustic ejector 306 of The ADE system 302 may generate acoustic energy that is applied to a liquid contained within a well 80 of the well plate 75 positioned on the movable plate stage 334. The generated acoustic energy may cause one or more sample droplets 125 to be ejected from the well 80 into the open end of the OPI probe 304.

A controller 330 may be operatively coupled to the ADE system 302 and may be configured to operate the ADE system 302. For example, the controller 330 may focus structures of the acoustic ejector 306 and control automation elements of the movable plate stage 334 so as to position a well 80 into alignment with the acoustic ejector 306 and/or the OPI probe 304. This enables the ADE system 302 to eject droplets 125 into the OPI probe 304. Controller 330 may be, but is not limited to, a microcontroller, a computer, a microprocessor, or any device capable of sending and receiving control signals and data. Wired or wireless connections between the controller 330 and the remaining elements of the mass spectrometer 300 are not depicted but would be apparent to a person of skill in the art.

The ESI source 314 may include a source of pressurized gas (e.g., nitrogen, air, or a noble gas) that supplies a high velocity nebulizing gas flow to the nebulizer probe 338 that surrounds the outlet end of the electrospray electrode 316. The electrospray electrode 316 protrudes from a distal end of the nebulizer probe 338. The pressured gas interacts with the liquid discharged from the electrospray electrode 316 to enhance the formation of the sample plume and the ion release within the plume for analyzing by mass analyzer detector 320. The liquid discharged may include discrete volumes of liquid samples LS received from each well 80 of the well plate 75. The discrete volumes of liquid samples LS are typically separated from each other by volumes of the solvent S. Hence, as flow of the solvent moves the liquid samples LS from the OPI probe 304 to the ESI source 314, the solvent may also be referred to herein as a transport fluid. The nebulizer gas may be supplied at a variety of flow rates, for example, in a range from about 0.1 L/min to about 20 L/min, which may also be controlled by controller 330 via opening and/or closing of an associated valve.

The flow rate of the nebulizer gas may be adjusted by controller 330 such that the flow rate of liquid within the sampling OPI probe 304 may be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 may be maintained at atmospheric pressure, though in some examples, the ionization chamber 318 may be evacuated to a pressure lower than atmospheric pressure.

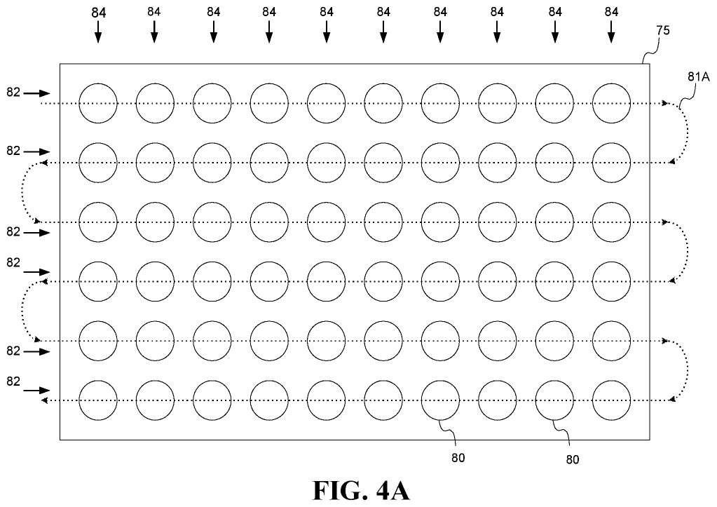

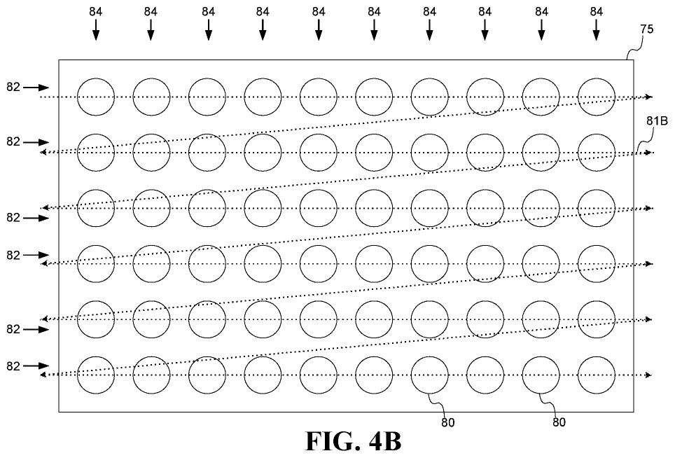

Further details of the well plate 75 and example sampling paths 81A, 82B are depicted in FIGS. 4A and 4B. As shown, the well plate 75 includes an array or matrix of wells 80. In particular, the well plate 75 includes rows 82 of wells 80. Furthermore, the wells 80 of the rows 82 are arranged in columns 84.

As noted above, the mass spectrometers 110, 300 may sequentially position each well 80 so that it aligns with probe 105, 304 and a sample may be ejected from the aligned well 80 into the probe 105, 304. To this end, FIG. 4A depicts a sampling path 81A in which wells 80 are sequentially sampled in alternating rows 82 from left-to-right and then right-to-left. In particular, after sampling the rightmost well 80 of a row 82 being sampled left-to-right, the well plate 75 and/or probe 105, 304 are positioned such that the rightmost well 80 of the next row 82 is sampled. Conversely, after sampling the leftmost well 80 of a row 82 being sampled right-to-left, the well plate 75 and/or probe 105, 304 are positioned such that the leftmost well 80 of the next row 82 is sampled. Thus, the sampling path 81A is akin to boustrophedon writing systems and may be referred to as a boustrophedon sampling path.

FIG. 4B depicts a sampling path 81B in which well 80 are sequentially sampled in rows 82 from left-to-right. As shown, after sampling the rightmost well 80 of a row 82 being sampled left-to-right, the well plate 75 and/or probe 105, 304 are positioned such that the leftmost well 80 of the next row 82 is sampled. Thus, the sampling path 81B is akin to sinistrodextral writing systems and may be referred to as sinistrodextral sampling path.

Other sampling paths may be used and/or may be essentially the same as the above sampling paths. For example, while the sampling paths 4A and 4B depict sampling the rows 82 of wells 80 in a top-to-bottom fashion, other embodiments may sample the rows 82 of wells 80 in a bottom-to top fashion. Furthermore, a sampling path may sample the wells 80 from right-to left akin to dextrosinistral writing systems. Moreover, while the sampling paths 81A and 81B sample the wells 80 along rows 82, other sampling paths may sample the wells 80 along columns 84. It should be appreciated that whether along columns or along rows is a matter of perspective as it merely requires a 90° rotation of the well plate 75 with respect to the plate stage 95, 334 to switch from sampling along rows 82 to along columns 84 of the well plate 75 and vice versa.

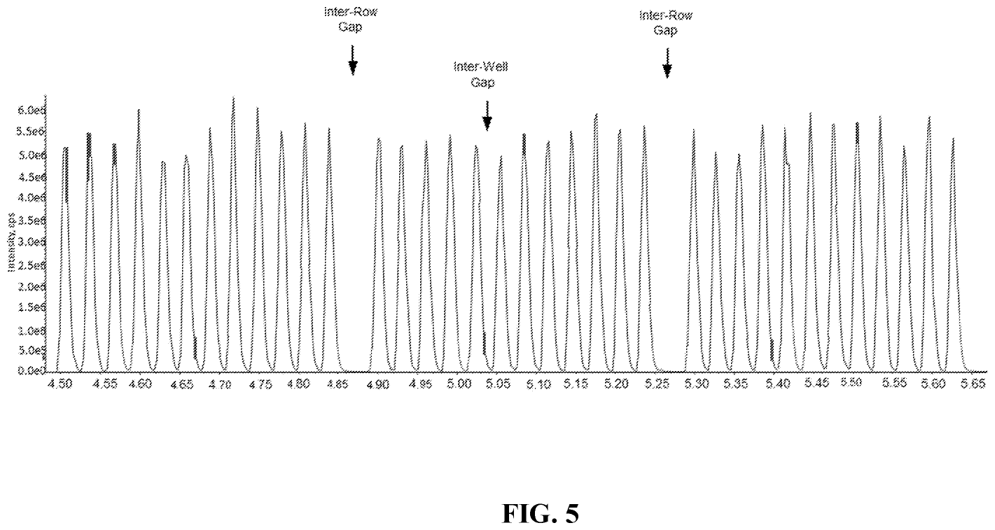

From the sampling paths 4A and 4B, it should be evident that physical alignment of the wells 80 with probe 105, 304 and the subsequent sampling of the aligned well 80 requires time. As such, there are sample gaps, which are further shown in FIG. 3 as solvent S separating samples LS. Moreover, it should be further appreciated that the gaps are larger when transitioning between rows 82 (e.g., moving from the rightmost well 80 to the leftmost well 80 in FIG. 4B) than when moving between wells 80 of the same row 82. These gaps may result in detectable gaps in the ion intensities detected by ion detector 126 and/or mass analyzer detector 320. In light of such gaps and/or changes in ion intensities, the computing device 130 may utilize such gaps to detect or associate spectral data generated by the mass spectrometer 110, 300 with rows 82 of wells 80. In some embodiments, the computing device 130 may further utilize such gaps or periods of reduced ion intensity to detect or associate spectral data with a particular well 80 or column 84 of wells 80. See, e.g., FIG. 5 which depicts spectral data for a row 82 of wells 80 as well as gaps or periods of reduced ion intensity that correspond to transitions between wells 80 in a row 82 of wells 80 and gaps or periods of reduced ion intensity that correspond between transitions between rows 82 of the well plate 75.

In various embodiments in accordance with the present disclosure, the mass spectrometers 110, 300 are time-of-flight (TOF) mass spectrometers in which mass-to-charge (mz) of ions are detected based on the amount of time it takes the ion to reach the ion detectors 126, 320. Historically, TOF mass spectrometers have introduced samples at relatively slow rate (e.g., on the order of minutes per sample) so as to provide a clear demarcation between detected ion intensities for each sample and the storage and/or transmission of the spectral data for each sample. Such TOP mass spectrometers were thus unable to process samples at a high rate (e.g., on the order of seconds per sample).

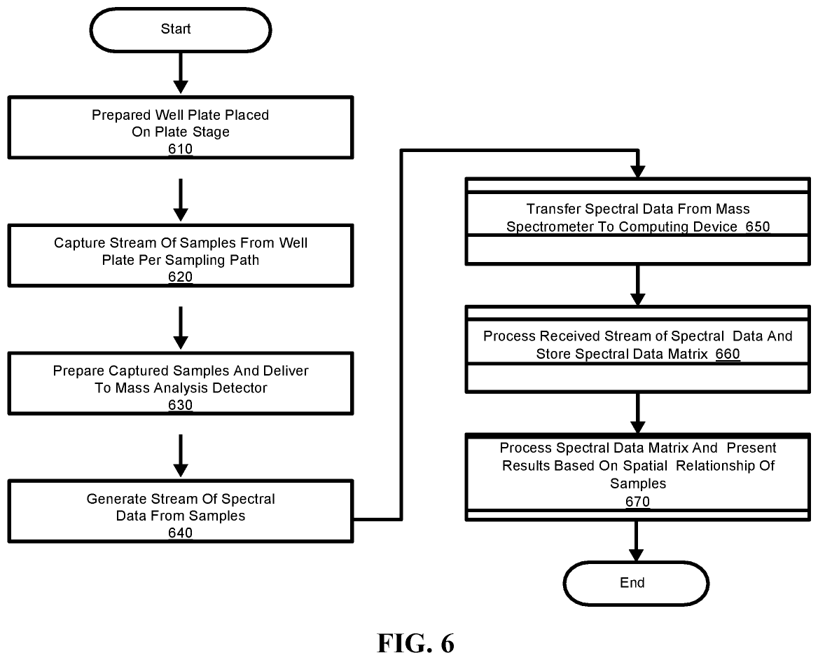

Referring now to FIG. 6, a flowchart depicts an embodiment of a mass analysis process 600 which may be implemented by the mass analysis system 100. In particular, the mass analysis process 600 may permit certain embodiments of the mass analysis system 100 to process samples at a high rate (e.g., on the order of seconds per sample). At 610, a user and/or robotic delivery system may deliver a well plate 75 to the mass spectrometer 300 for analysis. In particular, the well plate 75, with prepared samples in its wells 80, may be placed on the plate stage 334 of the mass spectrometer 300.

At 620, the computing device 130 may generate one or more signals or commands that instruct the mass spectrometer 300 to capture a stream of samples from the well plate 75. In response to such signals and/or commands, the controller 330 of the mass spectrometer 300 may cause the plate stage 334 and/or capture probe 105 to capture sample droplets 125 from the well plate 75 per a sampling path (e.g., sampling path 81A or 81B). For example, the controller 330 may move the OSI probe 304 up or down along a Z-axis into a desired position above the well plate 75, or otherwise place the OSI probe 304 at a desired position from which it may appropriately collect ejected droplets from one or more wells of the well plate 75. Moreover, the controller 128 may cause the plate stage 95 to position the well plate 75 such that a desired well 80 of the well plate 334 is aligned with the OSI probe 304.

After suitably positioning the OSI probe 304 and/or the well plate 75, the controller 330 may cause the ADE system 302 to eject one or more sample droplets 125 from a respective well 80 of the well plate 75 and may cause the OSI probe 304 to collect the ejected one or more sample droplets 125. For example, the ADE system 302 may use radio-frequency (RF) energy to generate sound through use of a transducer focus assembly (TFA), which generates focused ultrasound pulses near the surface of a specified sample in a well 80 of the well plate 75. Such ultrasound pulses may cause one or more sample droplets of a desired volume to be raised above the surface of the sample in the well 80 for capture by the OSI probe 304.

After capturing the sample droplets 125 for a respective well 80, the controller 330 may generate signals which repeat the process of moving the well plate 75 and/or the OSI probe 304 so as to align the next well 80 along the sampling path with the OSI probe 304 and capture sample droplets 125 from the newly aligned well 80. In this manner, the controller 330 may introduce of stream of sample droplets 125 into the mass spectrometer 300 per the sampling path across the wells 80 of the well plate 75.

At 630, the controller 330 may generate one or more signals and/or commands that prepare the captured sample droplets 125 and deliver a stream of samples S to the mass analysis detector 320. For example, the one or more signals and/or commands may cause the liquid handling system 322 to add dilutants, solvents, or other desired substances to the stream of captured sample droplets 125 to form a stream of samples S. The liquid handling system 322 may further deliver the stream of samples S to the ESI source 314 via conduit 325. The ESI source 314 may ionize the stream of samples and deliver the ionized samples as a stream of sample plumes to the ionization chamber 318, which is coupled to the mass analysis detector 320.

Using mass analysis techniques such as, for example, time-of-flight (TOF) mass spectrometry techniques, the mass analysis detector 320 at 640 may generate a stream of spectral data. The stream of spectral data may include, for each well 80 of the well plate 75, mass spectrum data representative of the detected mass-to-charge (mz) of ions in the respective ionized sample droplet 125. The mass analysis detector 320 at 650 may transfer the generated spectral data to the computing device 130 via its mass spectrometer interface 211. In some embodiments, the mass analysis detector 320 may stream the spectral data to the computing device 130 as the mass analysis detector 320 generates the mass spectrum data for each well 80 of the well plate 75. In other embodiments, the mass analysis detector 320 may store the spectral data to local storage (e.g., volatile or non-volatile memory, hard drive, etc.) of the mass spectrometer 300 before controller 330 relays the spectral data to the computing device 130 for further processing.

At 660, the computing device 130 may process the received spectral data and store a spectral data matrix to storage device 210. In some embodiments, the computing device 130 may store the received spectral data to the storage device 210 and generate the spectral data matrix based on the stored spectral data. To this end, the computing device 130 may detect rows of spectral data in the spectral data received from the mass spectrometer 300. Each row of spectral data may correspond to a row 82 of wells 80 in the well plate 75. Based on the detected rows of spectral data, the computing device 130 may generate the spectral data matrix such that each row 82 of wells 80 comprises a corresponding row of spectral data in the spectral data matrix.

As explained above with regard to FIGS. 4A, 4B, and 5, the spectral data generated by the mass spectrometer 300 may include gaps or periods of reduced ion intensity that correspond to transitioning of the OSI probe 304 between rows 82 of wells 60. In such embodiments, the computing device 130 may detect rows 82 of spectral data by detecting such gaps or periods of reduced ion intensity in the received spectral data. In some embodiments, the mass spectrometer 300 may generate the spectral data such that the spectral data includes a row marker after each row of spectral data. In such embodiments, the computing device 130 may detect rows 82 of spectral data by detecting such row markers in the received spectral data.

Beyond detecting rows of spectral data, the computing device 130 may further correlate mass spectrum data of the spectral data to a particular well 80 or column 84 of the well plate 75. Again, as explained above with regard to FIGS. 4A, 4B, and 5, the spectral data generated by the mass spectrometer 300 may include gaps or periods of reduced ion intensity that are associated with transitioning of the OSI probe 304 between wells 80 of a row 82 of wells 60. In such embodiments, the computing device may correlate mass spectrum data of the spectral data to a particular well 80 or a column 84 of wells 80 by detecting the gaps or periods of reduced ion intensity that are associated with transitioning of the OSI probe 304 between wells 80 in the row 82 of wells 80.

The computing device 130 at 670 may present results that are based on a spatial relationship of the samples of the well plate 75. For example, wells 80 of the well plate 75 may be populated with samples that differ in a specific manner (e.g., concentration of samples may increase across columns 84 of the well plate 75) or may be populated with the same sample across all wells 80. The computing device 130 may utilize various processing techniques such as various image processing techniques to extract and/or present spectral information based on spectral data of a matrix of wells 80 of the well plate 75. In some aspects, the image processing techniques may involve 3-dimensional peak finder algorithms.

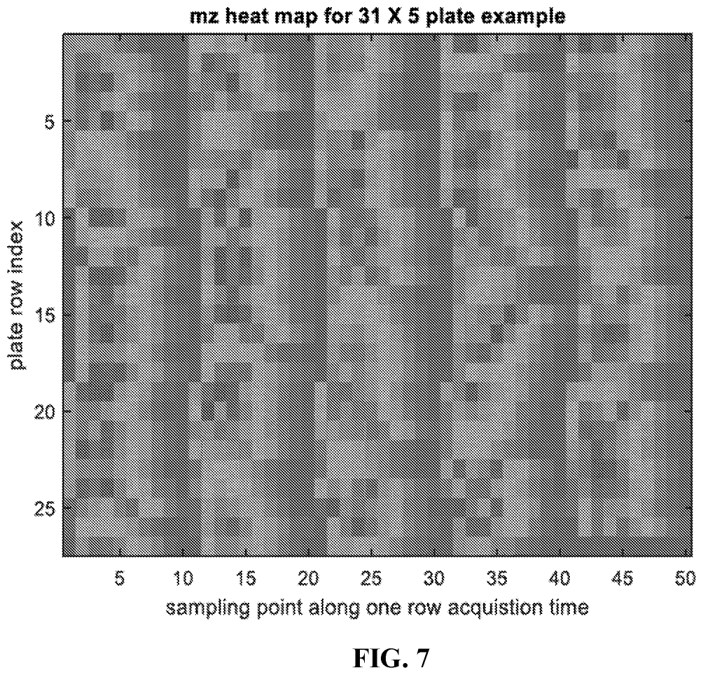

For example, the computing device 130 may generate and present via the display 212 a heat map for a mass-to-charge (mz) of interest as shown in FIG. 7. In particular, FIG. 7 depicts spectral data for a selected mz that are extracted from a spectral matrix generated from a well plate 75 having thirty-one rows 82 and five columns 84. For the selected mz, the computing device 130 may present a 31×5 matrix of blocks, wherein the shade/color of each block is based on the ion intensity of selected mz and wherein the position of the block corresponds to the position of the respective well 80 in the well plate 75. In one embodiment, the ion intensity is presented via a color continuum that ranges from blue to green to yellow to red. On such a continuum, wells 80 having samples providing very low ion intensity may be presented as dark blue, wells 80 having samples providing a medium-low ion intensity may be presented as green, wells 80 having samples providing a medium-high ion intensity may be presented as yellow, and wells 80 having samples providing a very high ion intensity may be present as bright red. Colors/shades in between the above may also be utilized. For example, the continuum may include 8, 16, 32, 64, or some other number of different levels of gradation.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Generally, embodiments of the present disclosure may be implemented through the use of computer program products embodied on computer-readable medium. Such computer program products may include instructions executable by processors and/or computing devices such as processor 204 and/or computing device 130.

While particular embodiments of the various aspects of the present disclosure have been illustrated and described, it would be apparent to those skilled in the art that various other changes and modifications can be made and are intended to fall within the spirit and scope of the present disclosure. Furthermore, although the present disclosure has been described herein in the context of particular implementations in particular environments for particular purposes, those of ordinary skill in the relevant arts will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A system, comprising
a well plate comprising rows of wells;
a mass spectrometer configured to sequentially capture a sample from each well of the rows of wells and generate spectral data that includes mass spectrum data for each captured sample; and
a computing device coupled to the mass spectrometer, the computing device configured to:
receive the spectral data generated by the mass spectrometer;
detect rows of spectral data in the spectral data, wherein each row of spectral data corresponds to a row of wells in the well plate; and
generate a spectral data matrix from the detected rows of spectral data such that each row of wells comprises a corresponding row of spectral data in the spectral data matrix.

2. The system according to claim 1, wherein the computing device is further configured to:
store the spectral data to a storage device, and
detect the rows of spectral data from the spectral data stored to the storage device.

3. The system according to claim 1, wherein the computing device is configured to store the spectral data matrix to a storage device.

4. The system according to claim 1, wherein:
the spectral data generated by the mass spectrometer comprises gaps that correspond to transitioning of a sample capture probe of the mass spectrometer between rows of wells; and
the computing device is configured to detect rows of spectral data based on the gaps that correspond to transitioning of the sample capture probe between rows of wells.

5. The system according to claim 1, wherein:
the spectral data generated by the mass spectrometer comprises periods of reduced ion intensity that correspond to transitioning of a sample capture probe of the mass spectrometer between rows of wells; and
the computing device is configured to detect rows of spectral data based on the periods of reduced ion intensity that correspond to transitioning of the sample capture probe between rows of wells.

6. The system of claim 1, wherein:
the mass spectrometer generates the spectral data to include a row marker after each row of spectral data; and
the computing device is configured to detect rows of spectral data based on the markers.

7. The system according to claim 1, wherein:
the spectral data generated by the mass spectrometer comprises gaps that correspond to transitioning of a sample capture probe of the mass spectrometer between wells in a row of wells; and
the computing device is configured to correlate spectral data to a particular well in the rows of wells based on the gaps that correspond to transitioning of the sample capture probe between wells in the row of wells.

8. The system according to claim 1, wherein:
the spectral data generated by the mass spectrometer comprises periods of reduced ion intensity that correspond to transitioning of a sample capture probe of the mass spectrometer between wells in a row of wells; and
the computing device is configured to correlate spectral to a particular well in the rows of wells based on the periods of reduced ion intensity that correspond to transitioning of the sample capture probe between wells in the row of wells.

9. A computing device, comprising:
an interface configured to receive spectral data from a mass spectrometer;
a storage device; and
a processor configured to execute instructions stored in a memory, wherein execution of the instructions causes the processor to:
detect rows of spectral data in the spectral data received from the mass spectrometer, wherein each row of spectral data corresponds to a row of wells in a well plate; and
generate a spectral data matrix from the detected rows of spectral data such that each row of wells in the well plate comprises a corresponding row of spectral data in the spectral data matrix.

10. The computing device according to claim 9, wherein execution of the instructions further causes the processor to:
cause the spectral data to be stored to the storage device, and
detect the rows of spectral data from the spectral data stored to the storage device.

11. The computing device according to claim 9, wherein execution of the instructions further causes the processor to store the spectral data matrix to the storage device.

12. The computing device according to claim 9, wherein execution of the instructions further causes the processor to detect rows of spectral data based on gaps that correspond to transitioning of a sample capture probe between rows of wells in the well plate.

13. The computing device according to claim 9, wherein execution of the instructions further cause the processor to detect rows of spectral data based on periods of reduced ion intensity that correspond to transitioning of a sample capture probe between rows of wells.

14. The computing device according to claim 9, wherein execution of the instructions further causes the processor to detect rows of spectral data based on markers in the spectral data.

15. The computing device according to claim 9, wherein execution of the instructions further causes the processor to correlate spectral data to a particular well in the rows of wells based on gaps that correspond to transitioning of a sample capture probe between wells in a row of wells.

16. The computing device according to claim 9, wherein execution of the instructions further causes the processor to correlate spectral data to a particular well in the rows of wells based on periods of reduced ion intensity that correspond to transitioning of the sample capture probe between wells in a row of wells.

17. A non-transitory computer-readable storage medium comprising instructions that, in response to being executed, cause a computing device to:
detect rows of spectral data in spectral data received from a mass spectrometer, wherein each row of spectral data corresponds to a row of wells in a well plate; and
generate a spectral data matrix from the detected rows of spectral data such that each row of wells in the well plate comprises a corresponding row of spectral data in the spectral data matrix.

18. The non-transitory computer-readable storage medium according to claim 17 comprising instructions that, in response to being executed, cause the computing device to:
store the spectral data to a storage device, and
detect the rows of spectral data from the spectral data stored to the storage device.

19. The non-transitory computer-readable storage medium according to claim 17 comprising instructions that, in response to being executed, cause the computing device to store the spectral data matrix to a storage device.

20. The non-transitory computer-readable storage medium according to claim 17 comprising instructions that, in response to being executed, cause the computing device to detect rows of spectral data based on gaps that correspond to transitioning of a sample capture probe between rows of wells in the well plate.

21. The non-transitory computer-readable storage medium according to claim 17 comprising instructions that, in response to being executed, cause the computing device to detect rows of spectral data based on periods of reduced ion intensity that correspond to transitioning of a sample capture probe between rows of wells.

22. The non-transitory computer-readable storage medium according to claim 17 comprising instructions that, in response to being executed, cause the computing device to detect rows of spectral data based on markers in the spectral data.
